(19) United States
(12) Patent Application Publication
(10) Pub. No.: US 2017/0221355 A1
(43) Pub. Date: Aug. 3, 2017

(54) Intelligent Light-supplementing LED System for VMSs and Traffic Signal Lights

(71) Applicant: CHAINZONE TECHNOLOGY (FOSHAN) CO., LTD, Foshan (CN)

(72) Inventors: Dasen Huang, Foshan (CN); Yun Peng, Foshan (CN); Guiyuan Lin, Foshan (CN); Zhenxiang Wang, Foshan (CN)

(21) Appl. No.: 15/414,660

(22) Filed: Jan. 25, 2017

(30) Foreign Application Priority Data
Jan. 29, 2016 (CN) 201610064859.8

(51) Int. Cl. G08G 1/095; F21V 7/22; F21V 23/04; G09F 13/16; F21V 29/89; G09F 13/22; G09F 9/33; F21V 5/04; F21V 23/02

(52) U.S. Cl. CPC G08G 1/095; F21V 5/04; F21V 7/22; F21V 23/04; F21V 23/02; F21V 29/89; G09F 13/22; G09F 9/33; G09F 13/16; F21Y 2115/10

(57) ABSTRACT

An intelligent light-supplementing LED system for message signs and traffic lights includes multiple optical lenses and LED units which are respectively provided behind each of the optical lens. The LED units include at least two LEDs connected in parallel; multiple LED units are connected in parallel to form a parallel system unit, or multiple LED units are connected in series to form a serial system unit. The parallel system unit is connected to a constant current power supply or a constant current circuit. The serial system unit is connected to a constant current power supply, a constant-voltage DC source, or a constant current circuit. So if an LED fails to light up, the total current that passes through the LED unit will have no or little change.

### CROSS REFERENCE TO RELATED APPLICATIONS

The present application claims the benefit of Chinese patent application No. 201610064859.8 filed on Jan. 29, 2016. All the above are hereby incorporated by reference.

### FIELD OF TECHNOLOGY

This invention relates to an intelligent light-supplementing LED system for VMSs and traffic signal lights.

### BACKGROUND

Since LED s have a long life-time span and a low failure rate, existing traffic signal lights as well as VMSs (Variable Message Signs), such as advertising displays and traffic lights, usually use LED as information display source. An optical lens is provided in front of each LED, in order to achieve directional light deliver. Once the LED is damaged, it will lead to damage to the transparent lens mounted in front of the LED and no light will be emitted. For big-size VMSs and traffic signal lights which contain a large number of LEDs, the failure probability thereof is much higher than a single LED; and moreover, these LEDs are usually connected in series, therefore the failure of one LED will impact an entire line or entire column of LEDs.

### SUMMARY OF INVENTION

The technical problem to be solved by the present invention is to provide a light-supplementing LED system for VMSs and traffic signal lights with a high reliability and a low failure rate.

A solution for the technical problem is a light-supplementing LED system for VMSs and traffic signal lights which comprises a plurality of optical lenses, and further comprises LED units respectively provided behind each of the optical lenses, wherein the LED unit comprises at least two LEDs in parallel, a plurality of LED units are connected in parallel to form a parallel system unit or are connected in series to form a series system unit, the parallel system unit is connected with a constant current power supply or a constant current circuit, and the series system unit is connected with a constant current power supply, a constant voltage direct current power supply or a constant current circuit.

As a further improvement of the above-described technical solution, a base frame having mounting holes is provided, and the optical lenses are mounted in the mounting holes.

As a further improvement of the above-mentioned technical solution, all the optical lenses formed as an integral optical lens unit.

As a further improvement of the above-described technical solution, a base frame having mounting holes is provided, and the optical lenses are mounted in the mounting holes.

As a further improvement of the above-described technical solution, a base frame having a mounting hole is provided, and the LED unit is an SMD packaged LED unit.

As a further improvement of the above-mentioned technical solution, the LED system includes a reflective support, and the LED is mounted on the reflective support.

As a further improvement of the above-mentioned technical solution, the reflective support is made of a heat conductive metal, and the inner side thereof is a reflector surface.

As a further improvement of the above-described solution, the number of LEDs (1) is three.

The beneficial effect of the invention is: since the LED unit comprises at least two LED, even if one LED fails and does not emit light, the constant current power supply or constant voltage DC power supply or constant current circuit connected with the LED unit will still allow the LED unit to provide the total current with no or little change, so that the current which would otherwise have passed through the faulty LED is detoured to the other LEDs and increases the light output of the intact LEDs. The total amount of light output is therefore basically unchanged. This realizes intelligent LED light supplementing while reducing the overall failure rate of the light unit. The present invention is applicable in LED message signs and traffic signal lights.

### BRIEF DESCRIPTION OF DRAWINGS

In order to more clearly illustrate the technical solutions of the embodiments of the present invention, the drawings which are required to be used in the description of the embodiments will be briefly described below. Obviously, the drawings described herein are only some but not all of the embodiments of the present invention. Other designs and drawings may also be obtained by those skilled in the art without any inventive effort.

FIG. 1 is a schematic structural view showing an LED unit according to embodiment a1 of the present invention;

FIG. 2 is a schematic structural view of a parallel system unit according to embodiment a2 of the present invention;

FIG. 3 is a circuit diagram of a parallel system unit according to embodiment a2 of the present invention; and

FIG. 4 is a schematic structural view of embodiment a3 of the present invention having both parallel system units and series system units.

### DETAILED DESCRIPTION

The concepts, particular structures and technical effects of the present invention will now be described with reference to the embodiments and accompanying drawings, for fully understanding the objects, features and effects of the present invention. Obviously, the described embodiments are only some but not all of the embodiments of the present invention. According to embodiments of the present invention, other embodiments obtained by a person skilled in the art without any inventive efforts all belong to the scope of protection of the present invention. In addition, all of the coupling/connection relationships mentioned herein do not refer to the direct connection of the members alone, but may also refer to the coupling structure which can be formed by adding or reducing the fittings according to the practical situations. The technical features of the present invention can be combined alternately when they do not contradict each other.

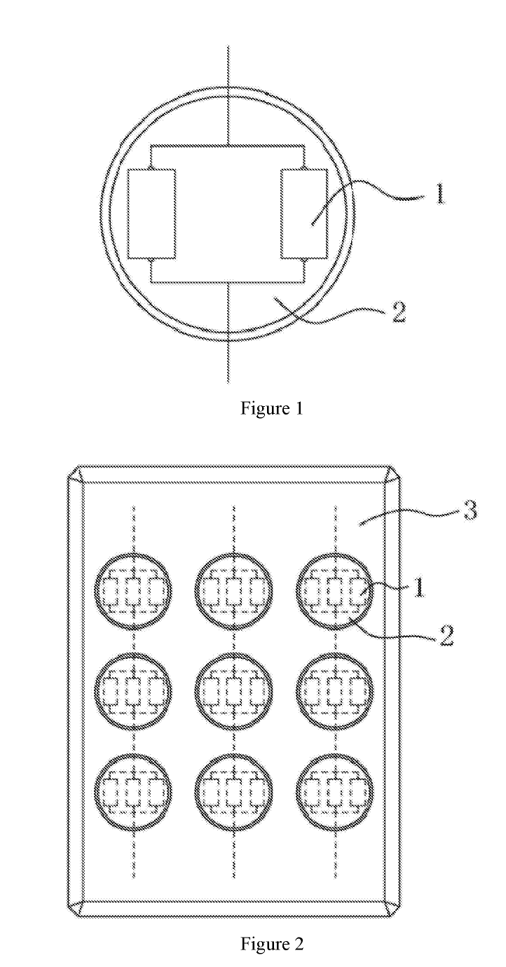

Refer to FIG. 1, which is an LED unit structure of embodiment a1 of the present invention.

An intelligent light-supplementing LED system for VMSs and traffic lights comprises a plurality of optical lenses 2, and further comprises LED units respectively provided behind each of the optical lenses 2, wherein the LED unit comprises at least two LEDs 1, and a current, which does not change along with the resistance of the system or which changes very little, passes through the LED unit. Since the LED unit comprises at least two LEDs 1, even if an LED 1 fails to light up, the total current that passes through the LED unit will have no or little change, so that the current which would otherwise have passed through the faulty LED 1 is detoured to another LED 1 and increases the light output of the intact LED 1. The total amount of light output is therefore basically unchanged. The LED unit is further processed by the optical lens 2. This realizes intelligent LED light supplementing while reducing the overall failure rate of the light unit. It would not be easy to found that one or more lights do not light up in the LED unit.

Refer to FIG. 2, which is embodiment a2 of the present invention.

An intelligent light-supplementing LED system for VMSs and traffic lights comprises nine optical lenses 2, and further comprises LED units arranged behind each of the optical lens 2. The LED unit comprises three LEDs 1 in parallel, and the optical lens 2 can uniformly mix the light emitted from all the LEDs 1 on the LED unit together and emit directionally. In this embodiment, three LED units are connected in series to form a series system unit. The present embodiment has three series system units. The three series system units are connected in parallel, and the series system units of the embodiment is connected to a constant current power source or a constant current circuit which is supplied with constant voltage, to realize constant current power supply.

Of course, if there are enough LED units in the series system unit to connect all the series system units in parallel or individually to the constant voltage DC power supply, even if there are a plurality of LED 1 in different LED units do not emit light due to failure, the total resistance of the series system unit is not changed; and thus, the total current passing through the series system unit is substantially constant, which results in that the total current passing through the failed LED unit is substantially constant and all the light emitting amount of LED remains basically unchanged.

For large devices, if all the LED units are connected in series into a series system unit, then the resistance will become very large, which leads to a corresponding increase in the driving voltage for the series system unit. However, because of safety and restriction on power supply voltage, the driving voltage cannot be increased unlimitedly. Moreover, processing and maintenance in such case are very difficult. Once poor welding happens, it is difficult to find where the poor welding is. Therefore the embodiment is made up of three series-connected system units connected in parallel so as to facilitate processing and maintenance and flexibly adapt to different driving power sources or constant current circuits.

In order to facilitate installation and maintenance, the embodiment also comprises a base frame 3 having a mounting hole in which the optical lenses 2 are mounted.

Of course, the optical lenses 2 can be integrally formed as an optical lens unit for ease of processing and assembly.

In order to avoid defective LED due to moisture and improve the reliability of the LED unit, the LED unit is an SMD packaged LED unit, which does not only simplify the manufacturing industry of the LED unit but is also suitable for large-scale industrial applications.

Of course, in order to further improve the luminous efficiency of the LED unit, a reflective support (not shown in the picture) is also provided, the number of which is adapted to that of the LEDs 1. The LEDs 1 are installed on the reflective support. The light emitted from the LED unit is radiated and condensed through the reflective support, and emitted from the LED unit through the optical lenses, so that the LED system can emit an even and soft light. At the same time, the reflective support can be made of any thermal conductive metal. In the embodiment, the reflective support is made of an aluminum material so as to provide a larger heat radiation area for the heat dissipation of the LED 1 and to improve the output power of the LED unit.

With the purpose of facilitating the replacement and knowing the failure rate of the LED unit, each LED 1 in parallel is provided with a switch and the LED 1 is connected to the constant DC voltage. The switch is generally on. When circuit detection is needed, the switches in two of the circuits are turned off. The LED which is located in a switched-on circuit but does not light up can be judged as defective. The switch cannot only determine the failure rate of each LED 1, but also serve as a conduction circuit enabling the LED unit to operate.

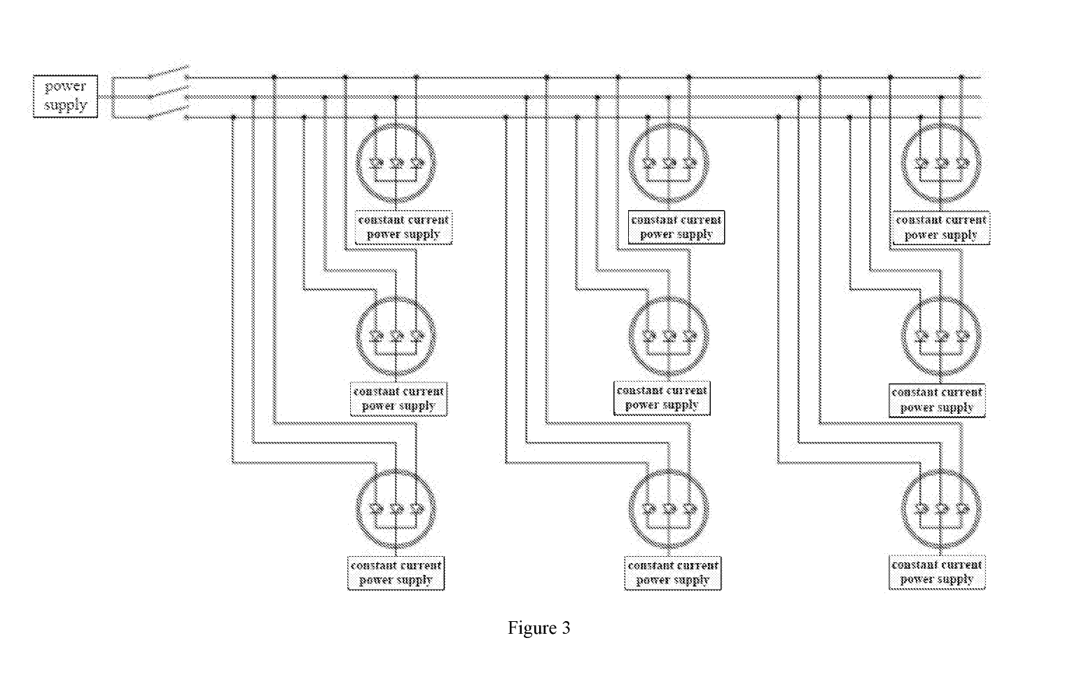

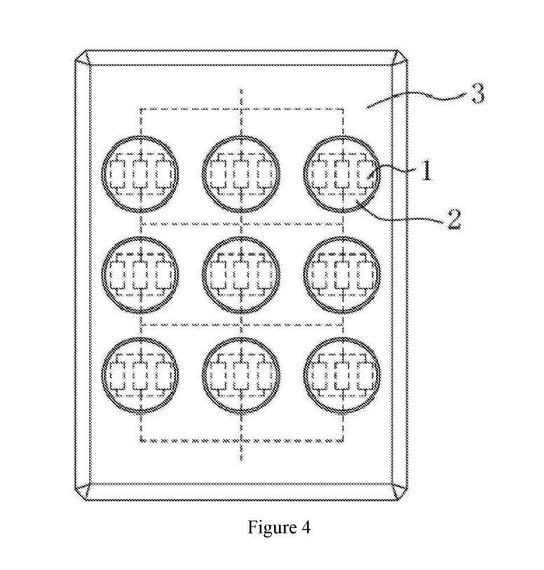

Refer to FIGS. 3 and 4, which is embodiment a3 of the present invention.

It consists of nine LED units connected in parallel to form parallel system units, and then all the parallel system units are connected in series together. Because embodiment a3 actually contains at least three series system units, it can use a constant voltage DC power supply or a constant current circuit or a constant current power supply to supply power to embodiment a3 so as to realize the function of intelligent light supplement.

The above contents have described the preferred embodiments of this invention in details. It should be understood that the invention is not limited to the described embodiments, and that those skilled in the art may make various equivalents or substitutions without departing from the spirit of the invention. These equivalent variants or substitutions are included within the scope of the claims of the present application.

What is claimed is:

1. An intelligent light-supplementing LED system for use in VMSs (Variable Message Sign) and traffic signal lights, comprising a plurality of optical lenses (2), LED units respectively provided behind each of the optical lenses (2), wherein the LED unit comprises at least two LEDs (1) in parallel, a plurality of LED units are connected in parallel to form a parallel system unit or are connected in series to form a series system unit, the parallel system unit is connected with a constant current power supply or a constant current circuit, and the series system unit is connected with a constant current power supply, a constant voltage direct current power supply or a constant current circuit.

2. The intelligent light-supplementing LED system for use in VMSs and traffic signal lights according to claim 1, further comprising a base support frame (3) with mounting holes, in which the optical lenses (2) are mounted.

3. The intelligent light-supplementing LED system for use in VMSs and traffic signal lights according to claim 1, wherein all the optical lenses (2) are formed as an integral optical lens unit.

4. The intelligent light-supplementing LED system for use in VMSs and traffic signal lights according to claim 1, wherein the LED unit is an SMD encapsulated LED unit.

5. The intelligent light-supplementing LED system for use in VMSs and traffic signal lights according to claim 1, wherein the LED system comprises a reflective holder and the LED units are mounted on the reflective support.

6. The intelligent light-supplementing LED system for use in VMSs and traffic signal lights according to claim 5, wherein the reflective support is made of a thermally conductive metal, and the inner side thereof is a reflector surface.

7. The intelligent light-supplementing LED system for use in VMSs and traffic signal lights according to claim 1, wherein the number of LEDs (1) is three.

8. The intelligent light-supplementing LED system for use in VMSs and traffic signal lights according to claim 7, wherein each LED (1) is provided with a switch.

9. The intelligent light-supplementing LED system for use in VMSs and traffic signal lights according to claim 2, wherein all the optical lenses (2) are formed as an integral optical lens unit.
